(19) United States
(12) Patent Application Publication
(10) Pub. No.: US 2024/0180187 A1
(43) Pub. Date: Jun. 6, 2024

(54) SUGAR-FREE CHEWY CONFECTIONERY AND METHOD OF MANUFACTURE

(71) Applicant: INTERCONTINENTAL GREAT BRANDS LLC, East Hanover, NJ (US)

(72) Inventors: Kiran Vyakaranam, East Hanover, NJ (US); Cesar Elejalde, East Hanover, NJ (US); Ewelina Bogdan-Smigielska, East Hanover, NJ (US); Tugba Oksuz, East Hanover, NJ (US); Weronika Baranowska, East Hanover, NJ (US)

(21) Appl. No.: 18/286,243

(22) PCT Filed: Apr. 29, 2022
(86) PCT No.: PCT/US2022/026944

§ 371 Date: Oct. 10, 2023

Related U.S. Application Data
(60) Provisional application No. 63/184,846, filed on May 6, 2021.

(51) Int. Cl. A23G 3/38; A23G 3/34; A23G 3/40; A23G 3/42; A23G 3/54

(52) U.S. Cl. CPC A23G 3/38; A23G 3/0014; A23G 3/40; A23G 3/42; A23G 3/54

(57) ABSTRACT

A method of producing a sugar-free chewy candy product includes cooking ingredients comprising a polyol bulk sweetener to obtain a cooked mass having a moisture content of 4% to 8%; adding a seeding material to the cooked mass while mixing to obtain a mixed mass; stoving the mixed mass at 30 to 80° C. to obtain a stoved mass; and forming the stoved mass into a desired shape to obtain a sugar-free chewy candy product.

### CROSS-REFERENCE TO RELATED APPLICATIONS

This application claims priority to U.S. Provisional Application No. 63/184,846, filed May 6, 2021, which is incorporated by reference in its entirety for all purposes.

### BACKGROUND

This disclosure generally relates to a sugar-free chewy confectionery and methods of making the sugar-free chewy confectionery.

Sugar-free comestibles are highly desired by consumers to meet certain dietary restrictions or for the distinct advantage of not contributing to tooth decay. However, commercial preparation of sugar-free chewy confectionary compositions poses unique challenges including processing considerations and stability considerations.

The level of chewiness or hardness/stiffness of a sugar-free confectionery composition is modulated by the amount of moisture present coupled with the type and degree of polyol crystallization. Typically, lower amounts of moisture result in a harder texture, while higher amounts of moisture result in a softer texture. The cooking temperature and time in preparing a confectionery composition determines the moisture content and thus affects the texture of the product. The type of crystallization also contributes to the overall texture of the product. Additionally, the degree of crystallization affects the confectionery composition's texture. Generally, the higher the degree of crystallization, i.e. the more grained the product is, the softer the bite. In some instances there can be an interaction between the type and degree of crystallization. Proper distribution of crystallized mass in the candy determines the texture of the product. Thus, by controlling the moisture content and the type and degree of crystallization in the final confectionery product, a range of textures can be obtained from chewy to hard/crispy.

Use of certain types of sugar alcohols (polyols) will result in more or less crystallization in a confectionery. The level of crystallization in a sugar-free confectionery product is highly specific to the type of polyol used. For example, changing the type of polyol while maintaining the polyol amount at the same level will impact the ability of the matrix to crystallize and deliver the correct texture.

Previous methods of making formulations of chewy candy with a polyol such as isomalt as the bulk sweetener would not produce the required softening/graining associated with sugar based chewy confectionery compositions. Usual process steps that produce the desired graining in sugar-based chewy confectionery compositions, such as shearing, short term heating, and cooling have been observed to not be effective in producing graining in confectioneries with polyol bulk sweeteners, such as isomalt. Additionally, known processes for making isomalt based confectionaries resulted in products that deformed easily during manufacture and exhibited poor dimensional stability and thus were unsuitable for commercial use.

Thus, there is a need for new processes to manufacture sugar-free chewy confectionary products and which produce products with properties desired by consumers.

### SUMMARY

Disclosed, in various embodiments, are a method of producing a sugar-free chewy candy product and the sugar-free chewy candy product produced by the method.

A method of producing a sugar-free chewy candy product includes cooking ingredients comprising a polyol bulk sweetener to obtain a cooked mass having a moisture content of 4% to 8%; adding a seeding material to the cooked mass while mixing to obtain a mixed mass; stoving the mixed mass at 30 to 80° C. to obtain a stoved mass; and forming the stoved mass into a desired shape to obtain a sugar-free chewy candy product.

A sugar-free chewy candy product includes a solid polyol, a polyol syrup, an emulsifier, a fat, and a hydrocolloid, wherein the chewy candy product has a moisture content of about 4 to 8% w/w based on the total weight of the chewy candy product.

These and other features and characteristics are more particularly described below.

### BRIEF DESCRIPTION OF THE DRAWINGS

The following is a brief description of the drawings which are presented for the purposes of illustrating exemplary embodiments disclosed herein and not for the purposes of limiting the same.

FIG. 1 is a series of images showing the level of graining and deformability of a sugar-free chewy candy immediately after mixing at about 50° C. and before stoving (A), after stoving at 50° C. for 1 hour (B), and after stoving at 50° C. for 2 hours (C).

FIG. 2 is a graph of peak force determined for 80% penetration of a sugar-free candy mass determined as a function of stoving time.

FIG. 3 presents two photographic images comparing sugar-free candy pieces made by a standard method with forming before stoving (A) and sugar-free candy pieces made by an embodiment of the claimed method (B), with stoving performed before forming the pieces.

FIG. 4 is a flowchart showing an embodiment of the disclosed process to manufacture sugar-free chewy candy products. A dotted box denotes an optional step.

### DETAILED DESCRIPTION

A method of producing a sugar-free chewy confectionery product is disclosed herein. The inventors unexpectedly found that stoving a sugar-free candy mass prior to forming into a desired shape produces a sugar-free chewy candy that achieves the desired chewy grained texture and has advantageous properties for manufacture, notably the formed pieces are not sticky and do not deform during manufacturing. The method is particularly advantageous for production of sugar-free chewy candy in which the sugar-free bulk sweetener includes a major fraction of isomalt. The sugar-free chewy confectionery product and the packaged sugar-free chewy confectionery product are also disclosed.

Chewy confectionery is generally considered to be those confections with soluble components that allow a consumer to experience a chew texture with elasticity for a chew period of more than one minute. Chewy confections typically include bulk sweeteners, texturizing (gelling) agents, and fats. They can optionally include chew texture modifying agents to modify the chew texture. The terms “chewy candy” and “chewy confectionery” are used interchangeably herein.

Disclosed herein is a method of producing a sugar-free chewy candy product. The method comprises cooking ingredients comprising a polyol bulk sweetener to obtain a cooked mass having a moisture content of 4% to 8%; adding a seeding material to the cooked mass while mixing to obtain a mixed mass; stoving the mixed mass at 30° C. to 80° C. to obtain a stoved mass; and forming the stoved mass into a desired shape to obtain a chewy candy product. The method can further comprise mixing the ingredients prior to cooking the ingredients; cooling the cooked mass prior to adding the seeding material; cutting the desired shape into pieces; coating the pieces; and/or packaging the pieces.

The method of producing a sugar-free chewy candy product is shown schematically in the flowchart of FIG. 4. The ingredients of the candy base are cooked to form a cooked candy mass (20). Seeding material is added to the cooked mass while mixing (30), and then the seeded candy mass is stoved (40). After stoving, the candy mass is formed into a desired shape (50). Optionally, the ingredients of the candy base can be combined and mixed (10) prior to the cooking step (20).

The method differs from conventional methods used to manufacture sugar-containing chewy confectionery products at least in stoving the candy mass prior to forming the candy mass into a desired shape, e.g., pieces. Conventional methods developed for chewy sugar-containing candies stove only after the candy mass has been shaped into pieces. Stoving the sugar-free candy mass prior to forming the mass into a desired shape results in structural integrity and reduced stickiness of the formed sugar-free candy pieces, allowing for easier further processing of the pieces, for example coating the pieces. In particular, when isomalt is a major component of the polyol bulk sweetener, the disclosed method successfully produces an isomalt-containing chewy confectionery product with a time-stable soft chewy texture that is desirable to a consumer. In contrast, isomalt-containing chewy candy products obtained by methods in which stoving occurs later in the process, after shaping the candy mass, result in products that stick to each other as well as to human skin and have a higher rate of deformation during subsequent processing steps. The sugar-free chewy candy products obtained by the claimed method are free-flowing rather than sticky and are substantially free of concave surface deformities that are aesthetically displeasing to consumers.

Cooking the ingredients to obtain a cooked mass having a moisture content of 4% to 8% can be performed at any suitable temperature. For example, for an isomalt-containing polyol bulk sweetener, cooking can be performed at 100 to 160° C., 110 to 145° C., 125 to 135° C., or 125 to 130° C. In certain embodiments the cooking temperature is preferably 125 to 130° C. The moisture content can be determined by methods known in the art, for example by monitoring the weight of the mass to evaluate the amount of water evaporated from the mass and determine the remaining water content of the mass.

A seeding material is added to the cooked mass while mixing to seed crystallization of the polyol bulk sweetener in the mixed mass. Examples of seeding material include crystalline forms of a polyol, for example erythritol, isomalt, lactitol, maltitol, mannitol, sorbitol, xylitol, or a combination thereof. The seeding material is added to the cooked mass in an amount of at least about 0.75% weight/weight (w/w), about 1% w/w, about 1.5% w/w, about 2% w/w, about 3% w/w, about 4% w/w, or about 5% w/w and at most about 10% w/w, about 12.5% w/w, about 15% w/w, or about 18% w/w based on the total weight of the cooked candy mass.

In certain embodiments, the seeding material is a crystalline polyol identical to the solid polyol of the polyol bulk sweetener. For example, when the solid polyol of the bulk sweetener is isomalt, the seeding material can be crystalline isomalt. The crystalline isomalt for seeding is added in an amount of at least about 0.75% w/w, about 1% w/w, about 1.5% w/w, about 2% w/w, about 3% w/w, about 4% w/w, or about 5% w/w o and at most about 10% w/w, about 12.5% w/w, about 15% w/w, or about 18% w/w based on the total weight of the cooked candy mass. In certain embodiments, the crystalline isomalt is added at about 1 to about 10% w/w based on the total weight of the cooked mass. An exemplary crystalline isomalt for seeding crystallization is Isomalt ST-PF (Beneo). The crystalline isomalt can be added about 0.5 to about 2 minutes, or about 1 to about 1.5 minutes after mixing the cooked mass begins.

Mixing the seeding material and the cooked candy mass can be performed by any suitable method. For example, any suitable mixer with some means of temperature control can be used. Exemplary mixers include a sigma mixer, a Z-blade mixer, and other twin blade batch mixers, as well as continuous mixers.

Mixing the cooked mass and seeding material to obtain the mixed mass can be performed at a temperature of about 30° C. to about 80° C., about 40° C. to about 70° C., about 45° C. to about 60° C., or about 50° C. to about 55° C. In certain embodiments mixing the seeding material and the cooked candy mass is performed at a temperature of about 50° C. to about 55° C.

The method may comprise cooling the cooked mass prior to adding the seeding material. Cooling the cooked mass from the cooking temperature to the temperature for adding a seeding material to the cooked mass while mixing to obtain a mixed mass can be performed by any suitable method. For example, the cooked mass can be placed on a cooling belt or a cooling drum until the desired temperature is reached for adding a seeding material to the cooked mass while mixing to obtain a mixed mass.

The term “stoving” refers to a process of holding a candy mass in a constant temperature environment. Stoving the mixed mass is performed at a temperature of about 30° C. to about 80° C., about 40° C. to about 70° C., about 40° C. to about 60° C., or about 50° C. In certain embodiments, stoving can be performed in an enclosed chamber. Stoving can be performed at any relative humidity (RH), but is preferably performed at a relative humidity of less than about 30%, less than about 25%, less than about 20%, less than about 15%, less than about 10%, less than about 5%, or even lower.

In certain embodiments, the temperature at which the seeding material and the cooked mass are mixed differs from the temperature at which the mixed mass is stoved by no more than 10° C., no more than 5° C., or no more than 2° C.

Stoving the mixed mass is performed for a time sufficient to develop the desired texture in the stoved mass. Development of the desired texture with stoving time can be monitored by texture analysis of a sample of the candy mass.

The desired chewy texture in the candy mass is related to crystallization level of the polyol bulk sweetener in the candy mass. Therefore, alternatively, stoving the mixed mass is performed for a time sufficient to increase crystallization level of the stoved mass compared to crystallization level of the mixed mass. Crystallization level of a candy mass can be monitored by texture analysis of a sample of the candy mass.

In certain embodiments, stoving the mixed mass is performed at about 50° C. and about 10% RH for at least about 50 minutes, or at least about 60 minutes.

Texture analysis of a candy mass is performed using a texture analyzer. Suitable commercial texture analyzers include the TA.XT Plus Texture Analyzer (Stable Micro Systems, Surrey, UK, sold by Texture Technologies Corp. Scarsdale, New York), and any other comparable texture analysis instrument.

To quantitatively monitor development of chewy texture or crystallization level of a candy mass during stoving, samples can be tested for a chewy texture attribute using a TA.XT Plus Texture Analyzer, or any other comparable texture analysis instrument, using the manufacturer's software. Examples of quantitative texture parameters that can be used to characterize chewy texture include peak force. For example, the test to determine peak force can be run on a TA.XT Plus Texture Analyzer using a 1 inch (2.5 cm) diameter flat probe, a candy sample of at least 3 inches (7.6 cm) in diameter with a thickness of 8 mm, at a temperature of 50° C. The probe should be centered on the sample or if a round sample is not used then no edge of the probe should be less than 1 inch (2.5 cm) from the edge of the sample. The probe is pressed into the sample at a rate of 1 mm/sec to a penetration of 80% of the thickness (6.4 mm). The peak force measured during penetration of the sample to 80% of the thickness is recorded.

The stoving time can be a time sufficient to increase peak force measured on the stoved mass compared to peak force measured on the mixed mass. For example, the stoving time can be the time sufficient to increase peak force measured on the stoved mass compared to peak force measured on the mixed mass by about 50%, about 60%, about 70%, about 75%, about 80%, about 85%, about 90%, about 95%, about 100%, about 110%, about 120%, about 130%, or even greater. For example, the stoving time can be the time sufficient for peak force measured on the stoved mass to increase to a stable plateau level compared to peak force measured on the mixed mass. A stable plateau level of the peak force measured on the stoved candy mass means a peak force measurement that shows little or no growth or decline with further stoving time. For example, a stable plateau level of the peak force measured on the stoved candy mass can mean a peak force measurement that changes by no more than about 10% after about one additional hour of stoving the candy mass.

After stoving, the stoved candy mass can then be formed into any desired shape to obtain a chewy confectionery product. Shaping the stoved candy mass can be performed by any suitable method. For example, the candy mass can be run through sizing rollers and subjected to a chain die to produce pieces of a desired size and shape. An exemplary average thickness for a piece is about 10 mm, while an exemplary average weight for a piece is about 10 g. The pieces can then optionally be coated and/or packaged.

In an embodiment, the pieces are coated using materials and techniques known in the art. Exemplary surface treatments include panned coating (hard or soft), particulate coating (e.g., sanding, dusting, etc.), and treatment with oil optionally including flavors. The coating may be present in an amount from about 2 to about 60% w/w, specifically about 5 to about 45% w/w, and yet more specifically about 10 to about 30% w/w by weight of the total sugar-free chewy candy piece.

In an embodiment, the pieces are packaged using techniques and equipment known in the art.

The bulk sweetener for the sugar-free chewy candy is a polyol (sugar alcohol), preferably two or more polyols. Examples of a polyol include erythritol, galactitol, hydrogenated isomaltulose (isomalt), a hydrogenated starch hydrolysate, lactitol, maltitol, maltitol syrup, mannitol, polyglycitol, sorbitol, sorbitol syrup, xylitol, and mixtures thereof. A preferred combination of polyols making up the bulk sweetener is isomalt and a hydrogenated starch hydrolysate.

The total amount of polyol bulk sweetener present in the sugar-free confectionery product is about 50 to about 95% w/w based on the total weight of the confectionery product, about 70 to about 90% w/w o based on the total weight of the confectionery product, or about 75 to about 85% w/w based on the total weight of the confectionery product.

The polyol of the bulk sweetener can be used in solid or syrup form.

In certain embodiments, the polyol bulk sweetener comprises a solid polyol and a polyol syrup. The solid polyol can be present in the chewy confectionery product at about 35 to about 70% w/w, about 40 to about 65% w/w, or about 55 to about 60% w/w based on the total weight of the chewy confectionery product. The polyol of the solid polyol and the polyol of the polyol syrup can be the same or different.

Examples of polyol syrups include a hydrogenated starch hydrolysate, maltitol syrup, polyglycitol, sorbitol syrup, and mixtures thereof.

The solid polyol can be crystalline or amorphous. Polyols that can be crystalline include erythritol, isomalt, lactitol, maltitol, mannitol, sorbitol, xylitol, and a combination thereof. Without being bound by theory, when a crystalline polyol is used in the confectionery composition or when the polyol is allowed to crystallize in the composition, the resulting texture can become more grained or “short”, i.e., a crumbly or easily breakable texture. A benefit of a confectionery product having a short texture is that the confectionery disintegrates faster when chewed, which delivers the flavor faster.

In an embodiment, the solid polyol of the bulk sweetener is isomalt. Isomalt is a disaccharide alcohol that can be prepared by hydrogenating isomaltulose. Products of the hydrogenation can include 6-O-α-D-glucopyranosyl-D-sorbitol (1,6-GPS); 1-O-α-D-glucopyranosyl-D-sorbitol (1,1-GPS); 1-O-α-D-glucopyranosyl-D-mannitol (1,1-GPM); 6-O-α-D-glucopyranosyl-D-mannitol (1,6-GPM); and mixtures thereof. Some commercially available isomalt materials include an almost equimolar mixture of 1,6-GPS and 1,1-GPM. Other isomalt materials can include pure 1,6-GPS; 1,1-GPS; 1,6-GP; and 1,1-GPM. Still other isomalt materials can include mixtures of 1,6-GPS; 1,1-GPS; 1,6-GPM; and 1,1-GPM at any ratio. Exemplary commercially available isomalt includes Isomalt ST, Isomalt GS, Isomalt M, Isomalt DC, and Isomalt LM available from BENEO-Palatinit, Südzucker Group.

Isomalt can be present in the chewy confectionery product at about 35 to about 70% w/w, about 40 to about 65% w/w, or about 55 to about 60% w/w based on the total weight of the chewy confectionery product.

In an embodiment, the polyol syrup of the bulk sweetener is a hydrogenated starch hydrolysate. Hydrogenated starch hydrolysates include those disclosed in U.S. Pat. No. 4,279,931 and various hydrogenated glucose syrups and/or powders which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a line of commercially available products manufactured by Roquette Freres of France, and HYSTAR™, a line of commercially available products manufactured by Lonza, Inc., of Fairlawn, N.J., also can be useful. LYCASIN® is a hydrogenated starch hydrolysate including sorbitol and maltitol.

An exemplary hydrogenated starch hydrolysate is LYCASIN® 80/55, having about 75% solids, and containing polyols having a degree of polymerization (DP) of about 4% w/w sorbitol, about 53% w/w maltitol, about 22% w/w DP3-5, and about 21% w/w DP6 and greater. Another exemplary hydrogenated starch hydrolysate is LYCASIN® 80/55 HDS, having about 85% solids, and containing about 4% w/w sorbitol, about 53% w/w maltitol, about 22% w/w DP3-5, and about 21% w/w DP6 and greater.

In one embodiment, the polyol bulk sweetener comprises about 35 to about 60% w/w isomalt and about 30 to about 55% w/w hydrogenated starch hydrolysate syrup based on the total weight of the chewy candy product, or about 40 to about 60% w/w isomalt and about 35 to about 50% w/w hydrogenated starch hydrolysate syrup based on the total weight of the chewy candy product.

The ingredients of the chewy confectionery product can further comprise a fat. Suitable fats for use in the chewy confectionery product include partially or fully hydrogenated vegetable or animal fats, such as coconut oil, corn oil, cottonseed oil, palm kernel oil, peanut oil, sesame oil, soy bean oil, beef tallow, and lard, among others, as well as cocoa butter, milk fat, a glyceride, and the like. The fat of the confectionery composition can contain both trans fatty acids, non-trans fatty acids, or a combination thereof. In one embodiment, the fat is free of trans fatty acids. In one embodiment, the iodine value of the fat can be about 10 or less, specifically 5 or less. In another embodiment, the iodine value of the fat can be about 45 to about 55, specifically about 48 to about 53. Within this embodiment, the fat may contain monounsaturated fatty acids. The amount of fat present in the chewy confectionery product can be about 2.0 to about 6.0% w/w, or about 3.0 to about 5.0% w/w of the chewy confectionery product.

In one embodiment, a chewy confectionery product contains a fat having a melting temperature similar to body temperature to allow for good release of flavor and good chew texture when the confectionery composition is consumed. The melting temperature can be about 35 to about 40° C., preferably about 36 to about 39° C., and more preferably about 37 to about 38° C.

In one embodiment, the fat is palm oil, hydrogenated coconut oil, or a combination thereof.

The chewy confectionery product may further comprise a type and amount of texturizing agent to provide the desired texture characteristics to the finished chewy confectionery product. When higher amounts of the texturizing agent is used in a chewy confectionery composition, the composition has more body and tends to exhibit less cold flow shape deformation.

The texturizing agent can be selected from the group consisting of albumin, a hydrocolloid material such as natural gums, a cellulose (including polydextrose), a nanoclay, and a combination thereof. Examples of hydrocolloid materials include pectin, gum Arabic, alginates, agar, carageenans, guar gum, xanthan gum, locust bean gum, gellan gum, galactomannans, tragacanth gum, karaya gum, curdlan, konjac, chitosan, xyloglucan, beta glucan, furcellaran, gum ghatti, tamarin, gelatin, bacterial gums, and a combination thereof. A preferred hydrocolloid is gum arabic. In certain embodiments, the hydrocolloid is not gelatin.

The amount of texturizing agent in the chewy confectionery product can be about 0.5 to about 3.5% w/w, or about 1.0 to about 3.0% w/w, or about 1.5 to about 2.0% w/w based on the total weigh of the chewy confectionery product.

In some embodiments, the chewy confectionery composition further comprises an emulsifier. Examples of an emulsifier include glyceryl monostearate, lecithin, a fatty acid monoglyceride such as distilled monoglycerides, a diglyceride, propylene glycol monostearate, and a combination thereof. In some embodiments, the emulsifier is selected from a fatty acid monoglyceride, a lecithin, and a combination thereof. In some embodiments, the ratio of lecithin to fatty acid monoglyceride is about 1:3 to about 1:5.

The emulsifier cam be present in the chewy confectionery product in an amount of about 0.05 to about 1.0% w/w based on the total weight of the chewy confectionery product, about 0.1 to about 0.5% w/w based on the total weight of the chewy confectionery product, or about 0.1 to about 0.33% w/w based on the total weight of the chewy confectionery product. The chewy confectionery product can comprise lecithin in an amount of about 0.005 to about 0.1% w/w based on the total weight of the chewy confectionery product; and fatty acid monoglyceride in an amount of about 0.01 to about 0.4% w/w based on the total weight of the chewy confectionery product.

In one embodiment, the chewy confectionery composition comprises fat at 3 to 5% w/w, gum arabic at 1 to 3% w/w, sunflower lecithin at 0.02 to 0.08% w/w, and distilled monoglyceride at 0.1 to 0.3% w/w based on the total weight of the chewy confectionery product.

In some embodiments, the chewy confectionery composition can further comprise a food acid or salt thereof. The food acid or salt thereof is selected from the group consisting of acetic acid, adipic acid, ascorbic acid, butyric acid, citric acid, formic acid, fumaric acid, glyconic acid, lactic acid, phosphoric acid, malic acid, oxalic acid, sodium citrate dihydrate, succinic acid, tartaric acid, and a combination thereof. When present in the chewy confectionery composition, the food acid or salt thereof is present in an amount of about 0.5 to about 4.0% w/w based on the total weight of the chewy confectionery composition.

The chewy confectionery composition can further comprise an ingredient selected from an additional sweetener, a sensate, a flavor, a color, a functional ingredient, and a combination thereof.

The chewy confectionery composition can comprise a flavor in an amount of about 0.75 to about 3.0% w/w based on the total weight of the chewy confectionery composition. The chewy confectionery composition can comprise a mixture of a flavor and a food acid or salt thereof. In some embodiments, the ratio of flavor to food acid is about 1:1.

In some embodiments, the additional sweetener is a high intensity sweetener. A “high intensity sweetener” as used herein means agents having a sweetness greater than the sweetness of sucrose. In some embodiments, a high intensity sweetener has a sweetness that is at least 100 times that of sugar (sucrose) on a per weight basis, specifically at least 500 times that of sugar on a per weight basis. In one embodiment the high intensity sweetener is at least 1,000 times that of sugar on a per weight basis, more specifically at least 5,000 times that of sugar on a per weight basis. A suitable high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Combinations comprising one or more sweeteners or one or more of the foregoing types of sweeteners can be used.

In some embodiments, the sensate is selected from a cooling agent, a warming agent, a tingling agent, and a combination thereof.

In some embodiments, the functional ingredient is selected from a breath freshener, a dental care component, an active, an herbal, an effervescing system, an appetite suppressor, a vitamin, a micronutrient, a mouth moistening component, a throat care component, an energy boosting agent, a concentration boosting agent, and a combination thereof.

The following example are merely illustrative of the methods and products disclosed herein, and of their advantages, and are not intended to limit the scope hereof.

### EXAMPLES

### Example 1. General Formulation for Sugar-Free Chewy Confectionery Product

A general formulation for a sugar-free chewy confectionery product is shown in Table 1 below.

TABLE 1
Sugar-free chewy confectionery product

| Ingredient | % weight |
|---|---|
| water | 4-8 |
| polyol bulk sweetener | 50-95 |
| emulsifier | 0.05-1.0 |
| fat | 2-6 |
| Texturizing agent/hydrocolloid | 0.5-3.5 |
| seed material | 0.85 to 15% |
| total | 100 |

### Example 2. Process for Preparing a Sugar-Free Chewy Confectionery Product

A sugar-free chewy candy product is made starting with the ingredients shown in Table 2 and the process described below in which stoving is performed prior to shaping the candy mass. See FIG. 4 for a flowchart of the general method.

TABLE 2
Cooking system ingredients

| Ingredient | % weight |
|---|---|
| Water | 7.47 |
| Isomalt GS | 41.34 |
| Dimodan HP | 0.16 |
| LYCASIN 80/55 | 43.99 |
| Palm oil (nonhydrogenated) | 3.44 |
| Lecithine de tournesol | 0.04 |
| (sunflower lecithin) | |
| Gum Arabic (50% water solution) | 3.56 |
| Total | 100 |

A gum arabic water solution (50:50) is prepared for use. All ingredients for the mass to be cooked are combined, including the gum arabic water solution.

All ingredients are cooked together to about 125-130 C, with or without vacuum, with mixing, for about 40-50 minutes, with frequent determination of the weight of the mass after 20 minutes of cooking to monitor water evaporation from the mass and determine water content of the mass.

When the desired moisture content is reached (about 6%), the mass is poured onto a cooling drum and cooled to a desired temperature (e.g., 40-50° C.) and then transferred into a Z-blade mixer with a 40-50° C. water jacket. When the mass reaches the target mass temperature (about 50-55° C.), the mass is mixed for 20 minutes with the rear blade/front blade speeds set at 35/55 rpm, respectively. After 1 minute of mixing the mass is seeded with addition of crystalline Isomalt ST-PF powder in an amount of 1 to 10% w/w of the mass. After mixing, the mass temperature is about 50-55° C.

Samples about 8 mm thick of the candy mass are then stoved directly after mixing and before forming into pieces. Stoving conditions are 50° C. in an enclosed chamber at a relative humidity of about 10% for up to 2 hours.

Graining/crystallization of samples as a function of stoving time is tracked using texture analysis measurements, with additional visual observation of graining. Texture analysis measurements are made with a TA.XT Plus Texture Analyzer (Stable Micro Systems, Surrey, UK), with the raw data collected and analyzed using the manufacturer's software. The test is run using a 1 inch (2.5 cm) diameter flat probe, a sample of at least 3 inches (7.6 cm) in diameter with a thickness of 8 mm, and at a temperature of 50 C. The probe should be centered on the sample or if a round sample is not used then no edge of the probe should be less than 1 inch from the edge of the sample. The probe is pressed into the sample at a rate of 1 mm/sec to a penetration of 80% of the thickness (6.4 mm). The peak force determined for 80% penetration of the sample is recorded.

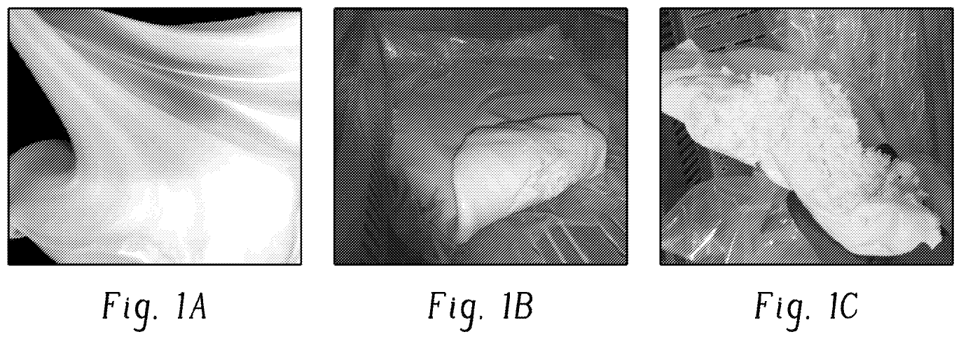

Visual observations of graining before and after stoving are illustrated in FIG. 1, a series of photographic images showing the isomalt-containing chewy candy mass immediately after mixing and before stoving (A), after stoving at 50° C. for 1 hr (B), and after stoving at 50° C. for 2 hrs (C). FIG. 1 shows the isomalt-containing chewy candy mass being transformed by stoving from a sticky, stretchy material that deforms easily (A) to one that ruptures instead of stretching and is not sticky (B and C). At time zero before any stoving (FIG. 1A), the sample is stretchy when pulled, indicating little or no crystallization. After stoving time progresses, the sample is not stretchy and breaks when pulled apart (FIG. 1A vs. 1C). Also, graininess is visually apparent at the broken edges of the stoved samples (FIGS. 1B and 1C) unlike the sample before stoving (FIG. 1A).

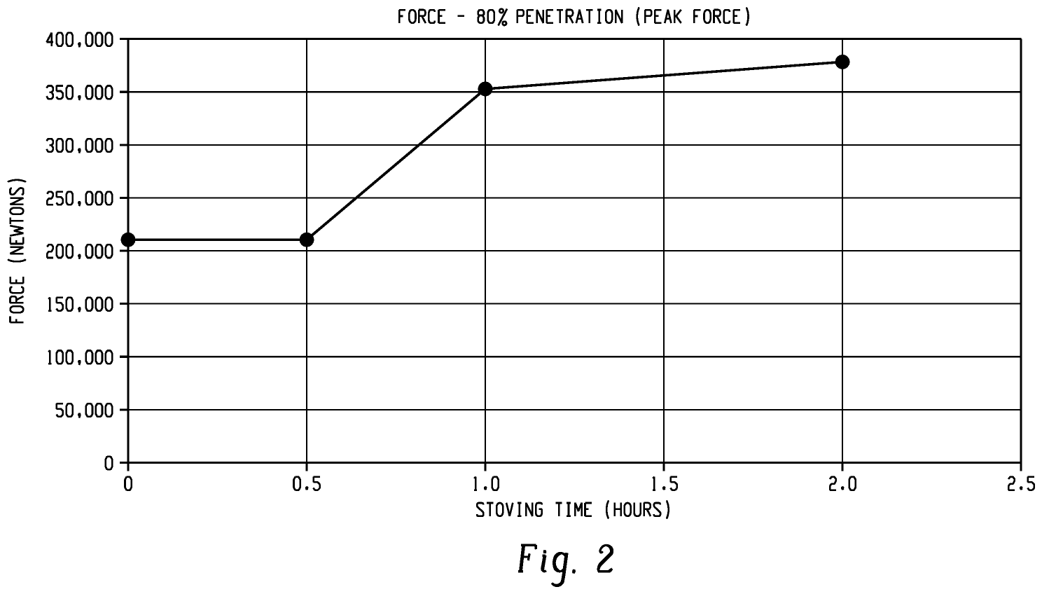

FIG. 2 is a graph of the measured peak force determined for 80% penetration by texture analysis as a function of stoving time on a candy mass stoved immediately after mixing. The measured peak force is unchanged for the first 0.5 hour of stoving and then increases from 0.5 to 1 hours and then is relatively constant at times between 1-4 hours. In fact, the candy mass texture, once changed, has been shown to be stable with stoving times at 50° C. up to 48 hours. These results show that the candy mass achieves a desirable chewy texture after only about one hour of stoving at 50° C. immediately after seeding and mixing and that the product properties stabilize after about one hour of stoving.

In summary, the visual observations and the texture analysis results both show that the candy mass reaches the desired texture after about 1 hour stoving and is relatively constant after that.

### Example 3. Comparative Isomalt-Containing Chewing Confectionery Products

Comparative isomalt chewy candy products were made using the same formulation as in Example 2 and a similar method except that stoving was performed only after shaping the candy mass, as in conventional methods of making chewy candies with sugar as bulk sweetener.

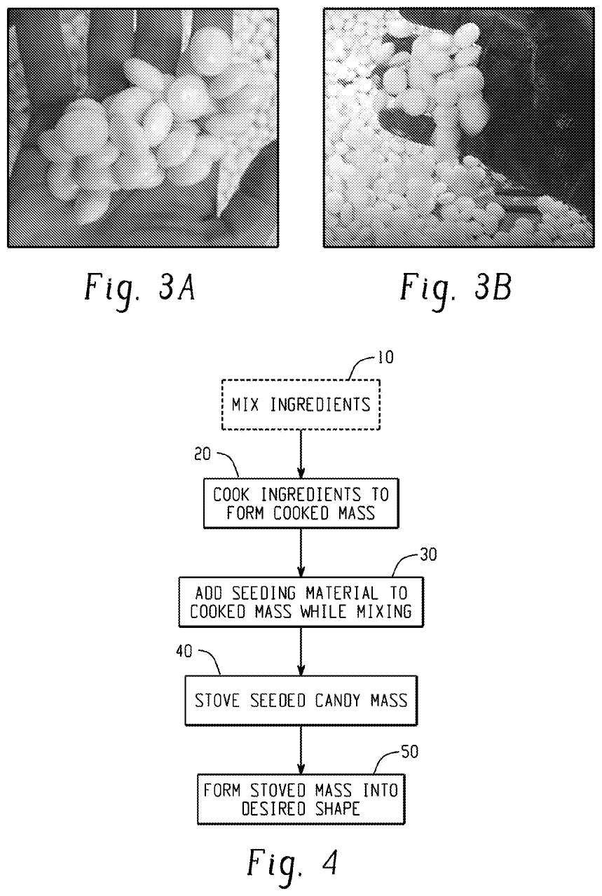

FIGS. 3A and B show photographic images of examples of the comparative sugar-free candy product (A) made by shaping followed by stoving and examples of the sugar-free candy product made by the claimed method (B) with stoving performed before shaping.

The sugar-free candy products made with stoving after shaping stick together and are easily deformable during subsequent normal processing steps. This is illustrated in FIG. 3A, a photograph of a hand holding a single clump of such sticky sugar-free candy products with deformations visible on several of the surfaces. In addition to the pieces sticking to each other, they also stick to the hand. In contrast, FIG. 3B shows sugar-free candy products made by the claimed method are free-flowing as they are dropped from the hand and do not stick together. The sugar-free candy products made by the claimed method are also much more resistant to deformation than the sugar-free candy products of FIG. 3A, made by standard processes with stoving after forming the candy mass.

The methods and confectionery products disclosed herein include at least the following aspects:

Aspect 1: A method of producing a sugar-free chewy candy product comprising cooking ingredients comprising a polyol bulk sweetener to obtain a cooked mass having a moisture content of 4% to 8%; adding a seeding material to the cooked mass while mixing to obtain a mixed mass; stoving the mixed mass at 30 to 80° C. to obtain a stoved mass; and forming the stoved mass into a desired shape to obtain a sugar-free chewy candy product.

Aspect 2: The method of aspect 1, wherein stoving is performed for a time sufficient to increase crystallization level of the stoved mass compared to crystallization level of the mixed mass.

Aspect 3: The method of aspect 2, wherein crystallization level of a candy mass is monitored by measurement of peak force of the candy mass

Aspect 4: The method of aspect 1, wherein stoving is performed for a time sufficient to increase peak force measured on the stoved mass compared to peak force measured on the mixed mass.

Aspect 5: The method of aspect 3 or 4, wherein the time is sufficient to increase peak force measured on the stoved mass compared to peak force measured on the mixed mass by 50%.

Aspect 6: The method of any one of the preceding aspects, wherein stoving is at 40 to 60° C.

Aspect 7: The method of any one of aspects 2 to 6, wherein the time is at least 30 minutes, preferably the time is at least 50 minutes when stoving is at 50 C.

Aspect 8: The method of any one of the preceding aspects, wherein stoving is performed in an enclosed chamber at a relative humidity (RH) of 5% to 20%.

Aspect 9: The method of any one of the preceding aspects, wherein the polyol bulk sweetener comprises a solid polyol and a polyol syrup

Aspect 10: The method of aspect 9, wherein the solid polyol comprises erythritol, galactitol, isomalt, a hydrogenated starch hydrolysate, lactitol, maltitol, mannitol, polyglycitol, sorbitol, xylitol, or a mixture thereof

Aspect 11: The method of aspect 9, wherein the polyol syrup comprises a hydrogenated starch hydrolysate syrup, a polyglycitol syrup, a maltitol syrup, a sorbitol syrup, or a mixture thereof.

Aspect 12: The method of any one of aspects 1 to 11, wherein the polyol bulk sweetener comprises 35 to 60% w/w isomalt and 35 to 50% w/w hydrogenated starch hydrolysate syrup, based on the total weight of the chewy candy product.

Aspect 13: The method of any one of aspects 1 to 12, wherein the ingredients further comprise a fat, a hydrocolloid, an emulsifier, or a combination thereof.

Aspect 14: The method of any one of aspects 1 to 13, wherein the ingredients further comprise 3 to 5% w/w fat, 1 to 3% w/w hydrocolloid, and 0.1 to 0.5% w/w emulsifier, based on the total weight of the chewy candy product,

Aspect 15: The method of any one of aspects 13 to 14, wherein the fat is palm oil, the hydrocolloid is gum arabic, and the emulsifier is lecithin and distilled monoglyceride.

Aspect 16: The method of any one of the preceding aspects, wherein cooking is at a temperature of about 110 to 145° C.

Aspect 17: The method of any one of the preceding aspects, wherein the seeding material is crystalline isomalt added in an amount of about 0.75 to about 15% w/w based on the total weight of the cooked mass.

Aspect 18: The method of any one of the preceding aspects, wherein mixing the cooked mass and seeding material to obtain the mixed mass is performed at a temperature of about 45° C. to about 60° C., preferably about 50° C. to about 55° C.

Aspect 19: The method of any one of the preceding aspects, further comprising mixing the ingredients comprising a polyol bulk sweetener; cooling the cooked mass prior to adding the seeding material; cutting the desired shape into pieces; coating the pieces; and/or packaging the pieces.

Aspect 20: A sugar-free chewy candy product made by the method of any one of the preceding aspects.

Aspect 21: A sugar-free chewy candy product, comprising: a solid polyol, a polyol syrup, an emulsifier, a fat, and a hydrocolloid, wherein the chewy candy product has a moisture content of about 4% w/w to about 8% w/w based on the total weight of the chewy candy product.

Aspect 22: The sugar-free chewy candy product of aspect 21, comprising 50 to 70% w/w isomalt and 25 to 45% w/w polyol syrup, based on the total weight of the chewy candy product, preferably the polyol syrup is a hydrogenated starch hydrolysate syrup

Aspect 23: The sugar-free chewy candy product of aspect 21 or 22, comprising 3-5% w/w fat, 1-3% w/w hydrocolloid, and 0.1-0.33% w/w emulsifier, based on the total weight of the chewy candy product.

Aspect 24: The sugar-free chewy candy product of any one of aspects 21 to 23, wherein the fat is palm oil, the hydrocolloid is gum arabic, and the emulsifier is lecithin and distilled monoglyceride.

Aspect 25: The sugar-free chewy candy product of any one of aspects 21 to 24 that is substantially free of concave surface deformities.

Aspect 26: The sugar-free chewy candy product of any one of aspects 21 to 25 that is coated, preferably the coating is present in an amount from about 2 to about 60% w/w, about 5 to about 45% w/w, or about 10 to about 30% w/w by weight of the total sugar-free chewy candy product

Aspect 27: A packaged sugar-free chewy candy product, comprising a plurality of the sugar-free chewy candy products of any one of aspects 20 to 26 or a plurality of the sugar-free chewy candy products prepared by the method of any one of aspects 1 to 19.

As used herein the terms “comprising” (also “comprises,” etc.), “having,” and “including” is inclusive (open-ended) and does not exclude additional, unrecited elements or method steps. The singular forms “a,” “an,” and “the” include plural referents unless the context clearly dictates otherwise. The endpoints of all ranges directed to the same component or property are inclusive of the endpoints, are independently combinable, and include all intermediate points and ranges (e.g., ranges of “up to 25 wt %, or more specifically 5 to 20 wt %” is inclusive of the endpoints and all intermediate values of the ranges of “5 to 25 wt %,” such as “10 to 23 wt %,” “20 to 24,” “1 to 5 wt %,” etc.). Disclosure of a narrower range or more specific group in addition to a broader range is not a disclaimer of the broader range or larger group. T The term “homogenous” refers to a uniform blend of the components. The word “or” means “and/or.” The terms “front”, “back”, “bottom”, and/or “top” are used herein, unless otherwise noted, merely for convenience of description, and are not limited to any one position or spatial orientation. “Optional” or “optionally” means that the subsequently described event or circumstance may or may not occur, and that the description includes instances where the event occurs and instances where it does not. In a list of alternatively useable species, “a combination thereof” means that the combination can include a combination of at least one element of the list with one or more like elements not named. Also, “at least one of” means that the list is inclusive of each element individually, as well as combinations of two or more elements of the list, and combinations of at least one element of the list with like elements not named. Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. In general, the compositions or methods may alternatively comprise, consist of, or consist essentially of, any appropriate components or steps herein disclosed. The invention may additionally, or alternatively, be formulated so as to be devoid, or substantially free, of any components, materials, ingredients, adjuvants, or species, or steps used in the prior art compositions or that are otherwise not necessary to the achievement of the function and/or objectives of the present claims.

The modifier “about” used in connection with a quantity is inclusive of the stated value and has the meaning dictated by the context (e.g., includes the degree of error associated with measurement of the particular quantity). The notation “+10%” means that the indicated measurement can be from an amount that is minus 10% to an amount that is plus 10% of the stated value.

Unless defined otherwise, technical and scientific terms used herein have the same meaning as is commonly understood by one of skill in the art to which this invention belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of producing a sugar-free chewy candy product comprising
cooking ingredients comprising a polyol bulk sweetener to obtain a cooked mass having a moisture content of 4% to 8%;
adding a seeding material to the cooked mass while mixing to obtain a mixed mass;
stoving the mixed mass at 30 to 80° C. to obtain a stoved mass; and
forming the stoved mass into a desired shape to obtain a sugar-free chewy candy product.

2. The method of claim 1, wherein stoving is performed for a time sufficient to increase crystallization level of the stoved mass compared to crystallization level of the mixed mass.

3. The method of claim 2, wherein crystallization level of a candy mass is monitored by measurement of peak force of the candy mass.

4. The method of claim 1, wherein stoving is performed for a time sufficient to increase peak force measured on the stoved mass compared to peak force measured on the mixed mass.

5. The method of claim 3, wherein the time is sufficient to increase peak force measured on the stoved mass compared to peak force measured on the mixed mass by 50%.

6. The method of claim 1, wherein stoving is at 40 to 60° C.

7. The method of claim 2, wherein the time is at least 30 minutes when stoving is at 50° C.

8. The method of claim 1, wherein stoving is performed in an enclosed chamber at a relative humidity (RH) of 5% to 20%.

9. The method of claim 1, wherein the polyol bulk sweetener comprises a solid polyol and a polyol syrup.

10. The method of claim 9, wherein the solid polyol comprises erythritol, galactitol, hydrogenated isomaltulose (isomalt), a hydrogenated starch hydrolysate, lactitol, maltitol, mannitol, polyglycitol, sorbitol, xylitol, or a mixture thereof.

11. The method of claim 9, wherein the polyol syrup comprises a hydrogenated starch hydrolysate syrup, a polyglycitol syrup, a maltitol syrup, a sorbitol syrup, or a mixture thereof.

12. The method of claim 1, wherein the polyol bulk sweetener comprises 35 to 60% w/w isomalt and 35 to 50% w/w hydrogenated starch hydrolysate syrup, based on the total weight of the chewy candy product.

13. The method of claim 1, wherein the ingredients further comprise a fat, a hydrocolloid, an emulsifier, or a combination thereof.

14. The method of claim 1, wherein the ingredients further comprise 3 to 5% w/w fat, 1 to 3% w/w hydrocolloid, and 0.1 to 0.5% w/w emulsifier, based on the total weight of the chewy candy product.

15. The method of claim 13, wherein the fat is palm oil, the hydrocolloid is gum arabic, and the emulsifier is lecithin and distilled monoglyceride.

16. The method of claim 1, wherein cooking is at a temperature of about 110 to 145° C.

17. The method of claim 1, wherein the seeding material is crystalline isomalt added in an amount of about 0.75 to about 15% w/w based on the total weight of the cooked mass.

18. The method of claim 1, wherein mixing the cooked mass and seeding material to obtain the mixed mass is performed at a temperature of about 45° C. to about 60° C.

19. The method of claim 1, further comprising
mixing the ingredients comprising a polyol bulk sweetener;
cooling the cooked mass prior to adding the seeding material;
cutting the desired shape into pieces;
coating the pieces; and/or
packaging the pieces.

20. A sugar-free chewy candy product made by the method of claim 1.

21. A sugar-free chewy candy product, comprising:
a solid polyol,
a polyol syrup,
an emulsifier,
a fat, and
a hydrocolloid,
wherein the chewy candy product has a moisture content of about 4% w/w to about 8% w/w based on the total weight of the chewy candy product.

22. The sugar-free chewy candy product of claim 21, comprising 50 to 70% w/w isomalt and 25 to 45% w/w polyol syrup, based on the total weight of the chewy candy product.

23. The sugar-free chewy candy product of claim 21, comprising 3-5% w/w fat, 1-3% w/w hydrocolloid, and 0.1-0.33% w/w emulsifier, based on the total weight of the chewy candy product.

24. The sugar-free chewy candy product of claim 21, wherein the fat is palm oil, the hydrocolloid is gum arabic, and the emulsifier is lecithin and distilled monoglyceride.

25. The sugar-free chewy candy product of claim 21 that is substantially free of concave surface deformities.

26. The sugar-free chewy candy product of claim 21 that is coated.

27. A packaged sugar-free chewy candy product, comprising a plurality of the sugar-free chewy candy products of claim 21.
